(19) United States
(12) Patent Application Publication
(10) Pub. No.: US 2022/0083975 A1
(43) Pub. Date: Mar. 17, 2022

(54) TIRE MANAGEMENT SYSTEM

(71) Applicant: TOYOTA JIDOSHA KABUSHIKI KAISHA, Toyota-shi Aichi-ken (JP)

(72) Inventor: Kitaru Matsuno, Nagoya-shi (JP)

(21) Appl. No.: 17/472,021

(22) Filed: Sep. 10, 2021

(30) Foreign Application Priority Data
Sep. 11, 2020 (JP) 2020-152805

(51) Int. Cl. G06Q 10/08; G06Q 10/06; G08B 21/18

(52) U.S. Cl. CPC G06Q 10/0875; G08B 21/18; G06Q 10/06316

(57) ABSTRACT

A tire management system comprises a management device which manages a storage state of a tire set in a storehouse provided with a plurality of storage spaces each capable of storing a single tire set; a worker terminal which is used by a worker working to unload or store the tire set; and an annunciator which is provided on each of the storage spaces and, when switched on, draws the worker's attention to a corresponding storage space; wherein when the tire set is unloaded or stored, the management device displays on the worker terminal an address of the storage space in the storehouse where the tire set is to be unloaded or stored, and also switches on the annunciator provided on the target storage space.

### CROSS REFERENCE TO RELATED APPLICATION

This application claims priority to Japanese Patent Application No. 2020-152805 filed on Sep. 11, 2020, which is incorporated herein by reference in its entirety including the specification, claims, drawings, and abstract.

### TECHNICAL FIELD

The present disclosure relates to a tire management system that manages a set of tires which are received from a customer and temporarily stored in a storehouse.

### BACKGROUND

To enable safer and more comfortable traveling, automobile tires are changed over depending on the season or the like. For example, standard tires are used through spring to fall and changed to tires for a snowy road in winter. Four tires (called a tire set below) removed from the automobile for changeover are required to be stored until they are used next time, but it is difficult for some users to secure a tire storage space. Therefore, there is a known service that receives and stores the tire set removed from the automobile until it is needed next time. The tire storage service stores a plurality of tire sets in a dedicated storehouse.

To manage the storage state of the tire sets in the storehouse, there is a tire management system that manages identification information of the tire sets in association with the addresses of the tire sets in the storehouse. When a single tire set is needed to be unloaded from the storehouse, the tire management system specifies the address of the tire set in the storehouse and notifies it to a worker. The worker goes to the notified address to find and unload the tire set. Also, when it is necessary to store a single tire set in the storehouse, the tire management system specifies an address in the storehouse where the tire set will be housed and notifies it to the worker. The worker transports the tire set to the notified address and houses the tire set at the designated address.

The storehouse generally has a wide space and it therefore takes time, or an error may occur when the stored location of the tire set is looked for based on only the address notified from the tire management system.

JP2004-250162A discloses a management system for efficiently managing a storage state in a storehouse. This management system shows the storage locations of stock articles in the storehouse as a flat type location image by converting into color coding depending on the number of stacked stock articles at the storage location. By applying the technology of JP2004-250162A to the tire storage service, the locations of tire sets are displayed as the flat type location image, and the worker can visually recognize the locations of tire sets, so that a burden on the worker for finding the tire set can be reduced to some extent.

However, in the case of JP2004-250162A, the worker needs to compare the location image shown on the display unit with the actual layout in the storehouse in order to find the needed stock article. Therefore, it was hard for the technology of JP2004-250162A to extensively reduce the burden on the worker when looking for the tire set. Specially, when the display unit is fixed at a specified location, the worker needs to look for the needed stock article while comparing the location image they have remembered with the actual layout in the storehouse, and an error tends to occur easily.

Under the circumstances described above, the present specification discloses a tire management system that makes the work of unloading or storing the tire set more accurate and simpler.

### CITATION LIST

PATENT LITERATURE: JP2004-250162A

### SUMMARY

The tire management system disclosed in the present specification comprises a management device which manages a storage state of a tire set in a storehouse provided with a plurality of storage spaces each capable of storing a single tire set; a worker terminal which is used by a worker working to unload or store the tire set; and an annunciator which is provided on each of the storage spaces and, when switched on, generates a visual or audible change to draw the worker's attention to a corresponding storage space; wherein when the tire set is unloaded or stored, the management device displays on the worker terminal an address of the storage space in the storehouse where the tire set is to be unloaded or stored, and also switches on the annunciator provided on the target storage space.

When the annunciator of the target storage space is switched on, the worker can readily find the target storage space without comparing the layout image shown on the display unit with the actual layout. As a result, the work of unloading or storing the tire set can be performed more accurately and simply.

In this case, the management device can switch off the annunciator provided on the storage space when the tire set is taken out from the target storage space or the tire set is stored in the target storage space.

By configuring as described above, a work completion storage space and a work non-completion storage space can be clearly distinguished from each other. Accordingly, the worker can be effectively prevented from wastefully conducting unnecessary work.

A tire sensor is also provided in the respective storage spaces to detect whether or not there is a tire set in the storage spaces; and the management device can manage the progress of the unloading and storing works of the tire set in accordance with the detection result of the tire sensor.

By configuring as described above, the progress of the unloading and storing work can be grasped accurately and quickly by the management device.

The management device can output an alarm if the tire sensor provided in the storage space, which is not an object of the unloading and storing work, has a change in the detection result of whether or not there is a tire set.

By configuring as described above, erroneous unloading of the tire set can be prevented effectively.

An identifier reader may also be provided in each of the storage spaces to read an identifier attached to the tire set stored in the storage space, and transmit the read result to the management device.

By configuring as described above, erroneous taking out of the tire set can be prevented effectively.

The management device includes a reservation database which records a tire set receiving or depositing reservation transmitted from outside, and a storehouse database which records the tire set arrangement in the storehouse; and when the management device receives a work initiation instruction from the worker terminal, it can specify the location of the tire set to be taken out from and stored in the storehouse in accordance with the reservation database and the storehouse database.

By configuring as described above, the worker can specify necessary operation contents easily and accurately.

Also, the tire management system further includes a pallet on which four tires configuring the tire set are placed in a vertically stacked state; and a platform cart which has wheels on its bottom surface and on which the four tires are placed and fixed together with the pallet; wherein the tire set can be stored in the storage space in a state placed on the pallet, and transported in a state placed on and fixed to the platform cart.

The tire set can be transported easily when it is placed on the platform cart. Also, by fixing the tire set to the platform cart, the four tires configuring the tire set can be prevented from separating from one another, and any tire of the single tire set can be prevented from being mixed into another tire set. Further, since the tire set is placed on the pallet, the tire set can be taken in and out from the storage space while the four tires configuring the tire set are kept in the stacked state.

The plurality of storage spaces are arranged vertically in two or more stages in the storehouse, and the management device can determine the number of stages of the storage spaces for storing the tire sets depending on the size of the tire set.

By configuring as described above, the tire set to be handled can be found more quickly.

According to the technology disclosed in this specification, the work of unloading or storing the tire set can be performed more accurately and simply.

### BRIEF DESCRIPTION OF DRAWINGS

Embodiment(s) of the present disclosure will be described based on the following figures, wherein:

FIG. 1 is an image view showing an overview of a tire storage service for which a tire management system is used;

FIG. 2 is a block diagram showing a structure of a control system of the tire management system;

FIG. 3 is a schematic diagram of a storehouse;

FIG. 4 is an image diagram showing a stored state of tire sets;

FIG. 5A is a perspective view of a pallet;

FIG. 5B is a perspective view of a platform cart;

FIG. 6 is a diagram showing examples of an identification tag;

FIG. 7 is a diagram showing an example of a reservation DB;

FIG. 8 is a view showing an example of a storehouse DB;

FIG. 9 is a view showing an example of a reservation calendar;

FIG. 10 is a view showing an example of a delivery schedule;

FIG. 11 is a diagram showing an example of a work confirmation screen;

FIG. 12 is a diagram showing an example of a map display screen;

FIG. 13 is a flowchart showing a flow of processing of a management apparatus in a tire set unloading and storing works;

FIG. 14 is a diagram showing a flow of the entire tire storage service;

FIG. 15 is a diagram showing the flow of the entire tire storage service; and

FIG. 16 is a block diagram showing a structure of a control system of another tire management system.

### EMBODIMENTS

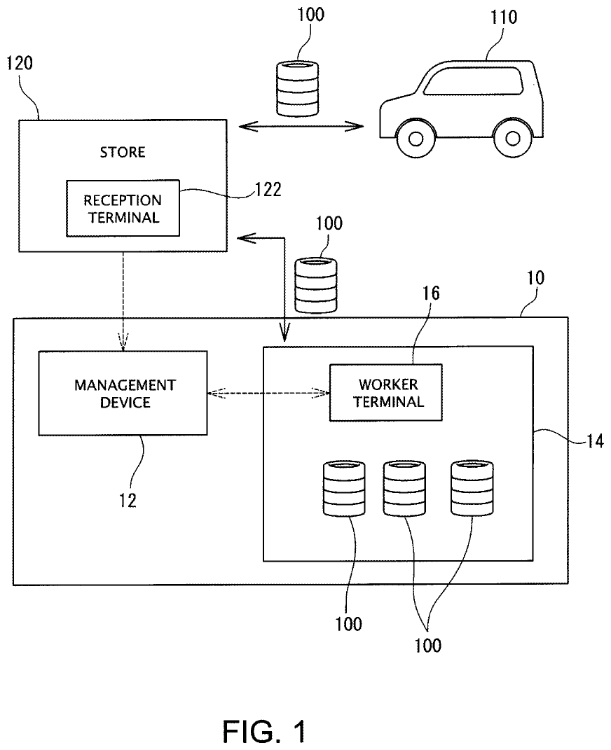

A configuration of a tire management system 10 is described below with reference to the figures. FIG. 1 is an image view showing an overview of a tire storage service for which the tire management system 10 is used.

For safe and comfortable traveling, automobile tires are changed over according to the season or the like. For example, standard tires are used through spring to fall and changed to tires for a snowy road in winter. The tire storage service is a service that accepts four tires removed from an automobile, namely a tire set 100, from a customer 110 and stores the tire set in a storehouse 14.

With the above service, the tire changeover work is performed by a particular store 120. Therefore, the customer 110 asks the store 120 to change tires. Upon receiving the tire changeover request, the store 120 requests the tire management system 10 to receive the tire set 100 of the customer 110 stored in the storehouse 14. The tire management system 10 specifies the tire set 100 of the customer 110 stored in the storehouse 14. Also, the specified tire set 100 is taken out from the storehouse 14 and delivered to the store 120.

The store 120 uses the received tire set 100 to change the tires over. After changing over the tires, the store 120 requests the tire management system 10 to deposit the tire set 100 removed from the automobile. Upon the deposit request, the tire set 100 removed from the automobile is delivered to the storehouse 14. The tire management system 10 specifies the storage location of the tire set 100 in the storehouse 14 and stores the delivered tire set 100 at the specified storage location.

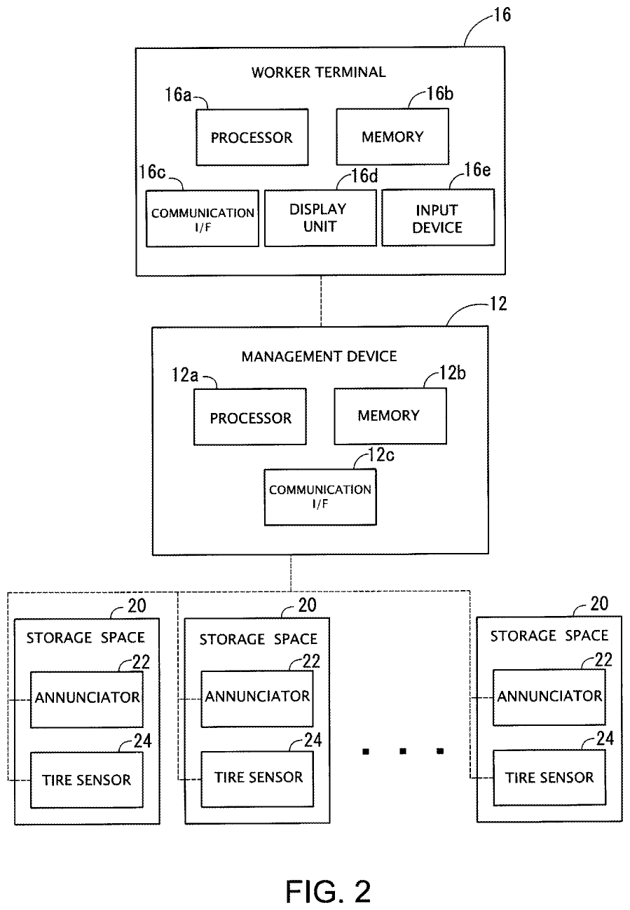

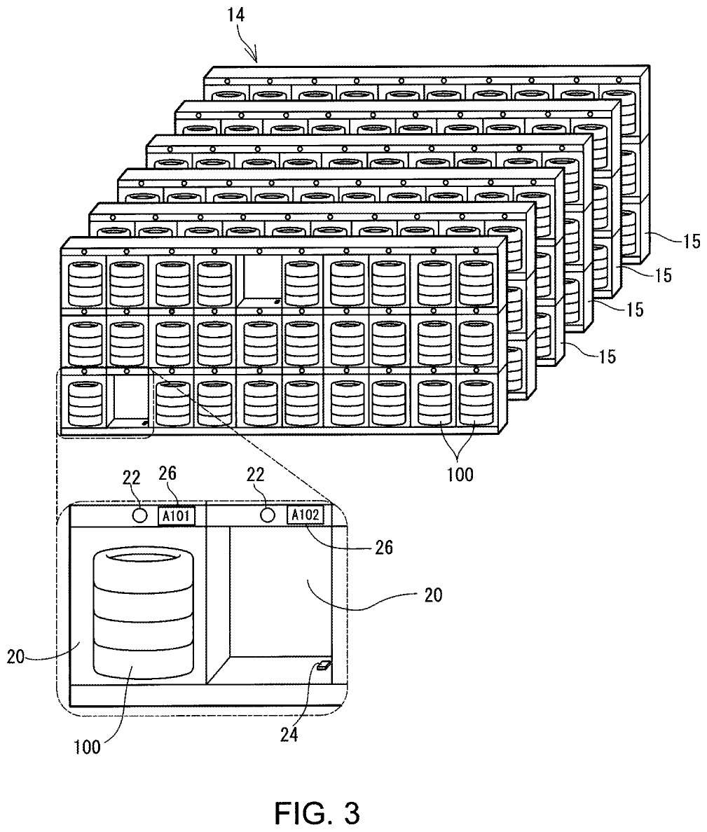

As shown in FIG. 1, the tire management system 10 includes the storehouse 14 in which a plurality of tire sets 100 are stored, a worker terminal 16 provided in the storehouse 14, and a management device 12 for managing the storage state of the tire sets 100 in the storehouse 14. Referring to FIG. 2 and FIG. 3, the configuration of the tire management system 10 will be explained in further detail. FIG. 2 is a block diagram showing the structure of the control system of the tire management system 10, and FIG. 3 is a schematic diagram of the storehouse 14.

The tire management system 10 includes the management device 12, the worker terminal 16, annunciators 22, and tire sensors 24. The management device 12 manages the storage states of the tire sets 100 in the storehouse 14 and, if necessary, generates various schedules and work inventories. The management device 12 is a computer physically including a processor 12a, a memory 12b, and a communication I/F 12c. This computer also includes a microcontroller which incorporates a computer system into a single integrated circuit. The processor 12a refers to a processor in a broad sense (for example, CPU: Central Processing Unit) and includes a dedicated processor (for example, GPU: Graphics Processing Unit, ASIC: Application Specific Integrated Circuit, FPGA: Field Programmable Gate Array, programmable logical device, and so on). The operation of the processor 12a described below is achieved not by a single processor only, but may be achieved by cooperation of a plurality of processors located physically separated from one another. Similarly, the memory 12b does not need to be one physical element, but can be configured of a plurality of memories located physically separated from one another. The memory 12b may include at least either one of a semiconductor memory (such as RAM, ROM, a solid-state drive, or the like) and a magnetic disk (such as a hard disk drive, or the like). The communication I/F 12c exchanges information with an apparatus provided outside the management device 12. Specifically, the management device 12 receives receiving and depositing reservations for the tire set 100 from a reception terminal 122 (see FIG. 1) via the communication I/F 12c. Also, the management device 12 communicates with the worker terminal 16 and also with the annunciators 22 and the tire sensors 24 in storage spaces 20 via the communication I/F 12c.

The worker terminal 16 is an information terminal which is provided within the storehouse 14 and can be used by the workers. The worker operates the worker terminal 16 to obtain a delivery schedule 46 and a work inventory, which will be described later, and performs various work in accordance with the obtained information. This worker terminal 16 is a computer physically including a processor 16a, a memory 16b, a communication I/F 16c, a display unit 16d and an input device 16e. The processor 16a described below is operated by a single processor only but can also be operated by cooperation of a plurality of processors located physically apart from one another. Similarly, the memory 16b does not need to be one physical element but may be configured of a plurality of memories located physically apart from one another. The memory 16b may also include at least one of a semiconductor memory (for example, RAM, ROM, a solid state drive, etc.) and a magnetic disk (for example, a hard disk drive, etc.). The communication I/F 16c exchanges information with an apparatus such as the management device 12 provided outside the worker terminal 16.

The display unit 16d displays various information and is configured of, for example, a liquid crystal display, an organic EL display or the like. The input device 16e accepts an input operation by the worker and includes at least one of, for example, a keyboard, a mouse, a touch panel, a microphone, and a joy stick. In this case, the display unit 16d is provided at a prescribed location in the storehouse 14 and the input device 16e is provided near the display unit 16d. However, the display unit 16d and the input device 16e may be a portable type that the worker can carry. When there are a plurality of workers, the display unit 16d and the input device 16e may be provided for each of the workers separately so that the plurality of workers can see the display unit 16d and operate the input device 16e at the same time. FIG. 1 and FIG. 2 show the worker terminal 16 as a device different from the management device 12, but the worker terminal 16 may be the same computer as the management device 12.

As described later, the storehouse 14 is provided with a plurality of storage spaces 20, and each storage space 20 houses a single tire set 100 therein. Each storage space 20 is provided with the annunciator 22 and the tire sensor 24. The annunciator 22 notifies the location of the storage space 20 to the worker. The tire sensor 24 detects whether a tire set 100 is in the storage space 20. The actual construction of the annunciator 22 and the tire sensor 24 is described later. The annunciator 22 and the tire sensor 24 are connected directly to the management device 12 or indirectly connected via a data repeater. The management device 12 switches on the corresponding annunciator 22 in accordance with the state of unloading or storing work of the tire set 100. The management device 12 receives a result detected by the tire sensor 24 and judges the progress of the unloading and storing work.

Then, the storage states of the tire sets 100 in the storehouse 14 are described by referring to FIG. 3. As shown in FIG. 3, the storehouse 14 has a plurality of shelves 15, and each shelf 15 has a plurality of storage spaces 20. Each of the storage spaces 20 houses a single tire set 100. As shown in FIG. 3, the storage spaces 20 are arranged in two directions, horizontal and vertical, in a matrix. In this case, the storage spaces 20 are vertically stacked in three stages.

The respective storage spaces 20 are given an address. The management device 12 stores the addresses of the storage spaces 20 in association with the tire sets 100 housed in the storage spaces 20. The respective storage spaces 20 are provided with an address plate 26, the annunciator 22, and the tire sensor 24. The address plate 26 is a plate on which the address of a corresponding storage space 20 is written and which is arranged at a position readily visible from the outside.

When the annunciator 22 is switched on, it generates a visual or audible change to draw the worker's attention to the storage space 20 where the annunciator 22 is provided. The annunciator 22 consists of, for example, a lamp, a display, a speaker, or a buzzer. In the present case, the annunciator 22 is a lamp which is lighted when switched on and not lighted when switched off. As described later in detail, when the tire set 100 is to be taken out, the management device 12 switches on the annunciator 22 corresponding to the tire set 100 that will be unloaded. Thus, the worker can easily recognize the location of the tire set 100 to be taken out.

The tire sensor 24 is a sensor for detecting whether or not there is a tire set 100 in the storage space 20. The tire sensor 24 is constituted of, for example, a weight sensor for detecting a weight of an object, a contact sensor for detecting whether or not there is contact with an object, an optical object sensor for optically detecting the presence or absence of an object, an ultrasonic sensor for detecting the presence or absence of an object by ultrasonic waves or the like. When such a sensor is used to detect the presence or absence of an object, the setting of the sensor's position and sensitivity becomes difficult if the object is significantly variable in size, shape and weight, and the presence or absence of the object cannot be detected accurately. However, the object to be detected by the sensor is limited to the tire set 100 in this case, and variations in size, shape and weight are within a prescribed range. Therefore, the presence or absence of the tire set 100 can be detected easily without specially adjusting the sensor's position and sensitivity. Below, the state where the presence of the tire set 100 is detected by the tire sensor 24 is called a “presence state” and the state that the presence of the tire set 100 is not detected is called an “absence state.”

The management device 12 determines the progress of the unloading and storing work of the tire set 100 in accordance with the result detected by the tire sensor 24. Specifically, when the presence state is switched to the absence state, the management device 12 determines that the tire set 100 has been taken out from the corresponding storage space 20, and when the absence state is switched to the presence state, the management device 12 determines that the tire set 100 has been housed in the corresponding storage space 20.

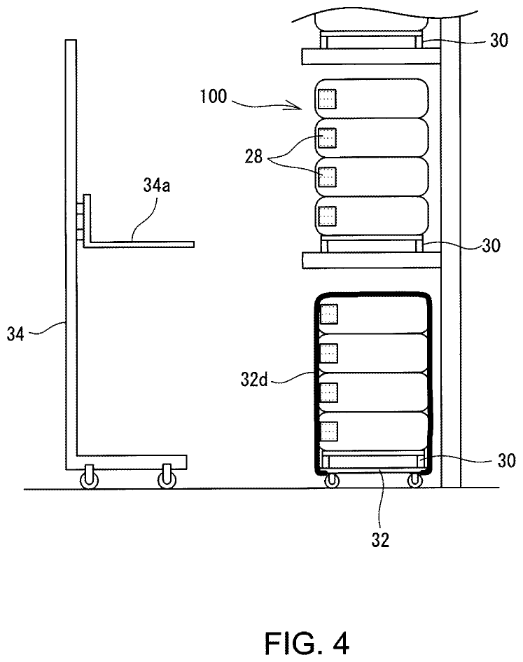

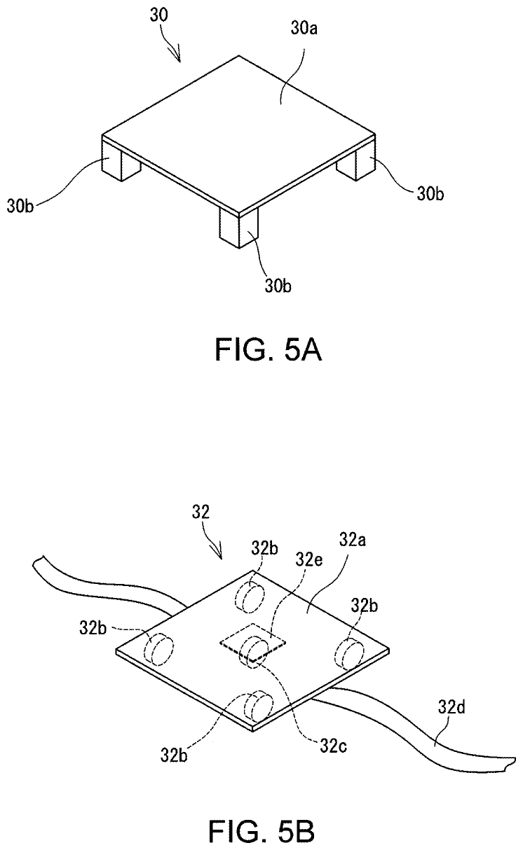

Here, FIG. 3 shows that the tire sets 100 are directly placed in the storage spaces 20, but the individual tire set 100 is actually housed in the storage spaces 20 in a state placed on a pallet 30 and transported in a state placed on a platform cart 32. The storage and transportation are described by referring to FIG. 4, FIG. 5A and FIG. 5B. FIG. 4 is an image view showing a stored state of the tire sets 100. FIG. 5A is a perspective view of the pallet 30 used for storing the tire set 100. FIG. 5B is a perspective view of the platform cart 32 used for transportation of the tire set 100.

As shown in FIG. 4, four tires constituting the tire set 100 are placed on the pallet 30 in a vertically stacked state and housed in the storage space 20. As shown in FIG. 5A, the pallet 30 has a base plate 30a on which tires are placed and legs 30b which are protruded downward from four corners of the base plate 30a. The legs 30b have a height larger than a thickness of a fork 34a of a lifter 34 described later. Therefore, when the pallet 30 is placed on a prescribed floor surface, a gap is formed between the base plate 30a and the floor surface so that the fork 34a can be inserted therein. Also, when the tire set 100 is placed on the pallet 30, the lifter 34 can be used to house the tire set 100 in the storage space 20 and to take the tire set 100 out therefrom.

The lifter 34 is an apparatus used to lift an article up and down. The lifter 34 has the fork 34a which can place the article on its upper surface and is moved vertically by a drive source (for example, a motor, a hydraulic cylinder or the like). To house the tire set 100 in the storage space 20 on the second or higher stage or to take out the tire set 100 from the same storage space 20, the worker places the tire set 100 with the pallet 30 onto the fork 34a of the lifter 34 and lifts the tire set 100 up or down. Thus, a burden on the worker can be reduced substantially by using the lifter 34 to house and take out the tire set 100.

The tire set 100 taken out from the storage space 20 is placed together with the pallet 30 on the platform cart 32 and transported by the platform cart 32. The platform cart 32 as shown in FIG. 5B has a base plate 32a, casters 32b, 32c fitted to the bottom surface of the base plate 32a, and a fastening belt 32d for fastening the tire set 100 to the platform cart 32. The casters are largely divided into the universal casters 32b provided at four corners of the base plate 32a and the stationary caster 32c attached to the center of the base plate 32a via a plate 32e. The fastening belt 32d extends in both lateral directions from the bottom surface of the base plate 32a and fastens the tire set 100 which is placed on the base plate 32a.

The tire set 100 taken out from the storage space 20 is transported to the store 120. In other words, the tire set 100 is carried from the storage space 20 to a transporting vehicle, loaded on the transporting vehicle, transported to the store 120 by the transporting vehicle, unloaded from the transporting vehicle, and carried from the transporting vehicle to the working location. The procedure is performed inversely when the tire set 100 is deposited. Accordingly, the tire set 100 is held in a state fastened to the platform cart 32 while it is carried from the storage space 20 to the work location in the store 120. By configuring in this way, the tire set 100 can be transported easily. The four tires configuring the tire set 100 are securely prevented from separating individually, so that a problem of any tire in the tire set 100 being mixed into another tire set 100 can be prevented effectively. The tire set 100 housed in the first stage storage space 20 does not require the use of the lifter 34. Therefore, the tire set 100 is not removed from the platform cart 32 but housed in the storage space 20 in the state fixed to the platform cart 32, as shown in FIG. 4.

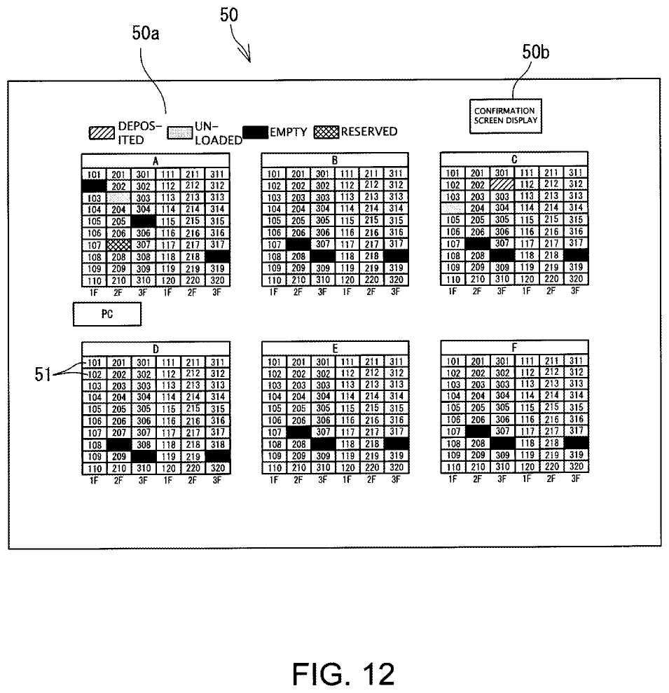

The storage position of the tire set 100 is determined by the management device 12, but the management device 12 may determine the storage position of the tire set 100 in accordance with at least either of the store 120 and the tire size. For example, in the case of FIG. 12 described later, the tire sets 100 are stored in the respective stores 120 where the tire sets 100 are reserved for storage. By configuring in this way, the worker can quickly grasp the location of the tire set 100 to be unloaded or stored. As described above, the storage spaces 20 are vertically arranged in three stages in this case. The management device 12 may determine the number of stages of the storage spaces 20 for storing the tire sets 100 according to the sizes of the tire sets 100. For example, it is possible that the tire sets 100 having a size belonging to a first range are stored in the first stage storage spaces 20, the tire sets 100 having a size belonging to a second range smaller than the first range are stored in the second stage storage spaces 20, and the tire sets 100 having a size belonging to a third range smaller than the second range are stored in the third stage storage spaces 20. Here, a large-size tire set 100 is heavy, so that a burden on the worker in charge of taking out it is large even if the lifter 34 is used. By storing the large-size tire set 100 in the first stage storage space 20, the burden on the worker taking out the large-size tire set 100 can be reduced. Also, the height of the storage space can be lowered, the burden of taking out can be reduced, and the efficiency of the storage space can be improved by distributing the large-size tire set 100 into the first stage, the intermediate size tire set 100 into the second stage, and the small size tire set 100 into the third stage.

As described above, the four tires configuring the tire set 100 are handled in the state mutually stacked vertically and rarely mixed in error into another tire set 100. However, as shown in FIG. 4, the tires are fitted with an identification tag 28 indicating identification information of each tire, just in case.

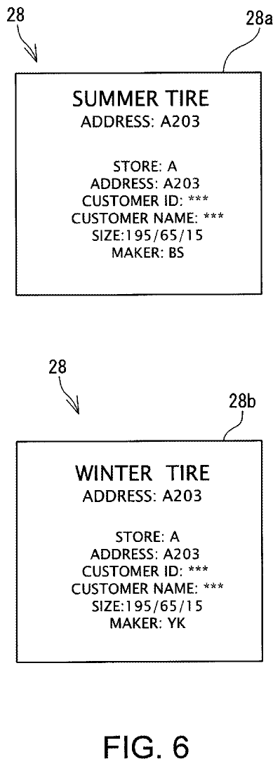

FIG. 6 is a diagram showing examples of the identification tag 28. For example, the identification tag 28 is made of a water proof sheet and attached to the tire with an adhesive tape or the like. The identification tag 28 in this case is provided in correspondence with the respective customers 110. Information about the tire set 100 for summer owned by the customer 110 is indicated on a front surface 28a of the identification tag 28 and information about the tire set 100 for winter owned by the customer 110 is indicated on a rear surface 28b. The information about the tire set 100 includes at least an ID of the customer 110 and an address of the storage space 20 where the tire set 100 is housed. In the case of FIG. 6, the identification tag 28 also includes a type (namely, summer tire or winter tire) of the tire set 100, a name of the store 120 where the tire set 100 is changed, a size of the tire set 100, and a manufacturer of the tire set 100. When the tires are removed from the automobile of the customer 110, the worker of the store 120 attaches the identification tag 28 to the tires and sends the tires to the storehouse 14. When the tires are taken out or stored, the worker of the storehouse 14 visually checks the identification tag 28 to identify each tire set 100 if necessary.

Next, a method of managing the tire set 100 will described. For management of the tire set 100, the memory 12b of the management device 12 stores a reservation DB 40 and a storehouse DB 42.

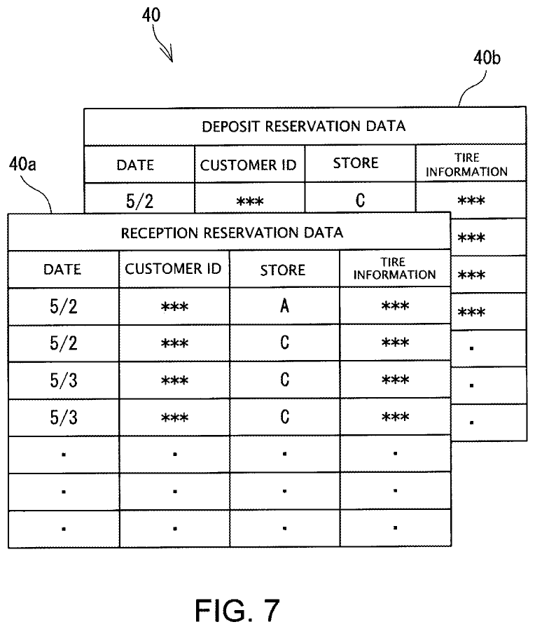

FIG. 7 is a view showing an example of the reservation DB 40. If necessary, the store 120 reserves in the management device 12 the receipt of the tire set 100 stored in the storehouse 14 and the deposit of the tire set 100 received from the customer 110 into the storehouse 14. The reservation DB 40 is data that records the reception reservation and the deposit reservation. In this case, the reservation DB 40 includes reception reservation data 40a that records the receiving reservation and depositing reservation data 40b that records the deposit reservation. The reception reservation data 40a and the deposit reservation data 40b each include the corresponding date, customer ID, store name and tire information of each reservation. Here, the date is a date when the tire set 100 is received at the store 120 or a date when the tire set 100 to be deposited is sent from the store 120. The customer ID is an identification code of the customer 110 who owns the tire set 100 to be received or deposited. The store name is a name of the store 120 for which the reservation is made. The tire information is information about the tire set 100 to be received or deposited, such as a tire size, a manufacturer name and the like. The management device 12 updates the reservation DB 40 every time it accepts the reception reservation and the deposit reservation from the store 120.

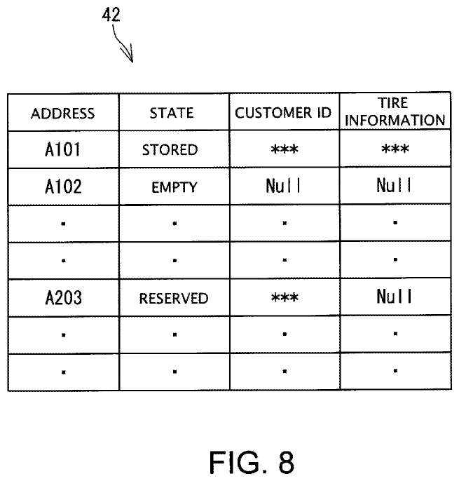

FIG. 8 is a view showing an example of the storehouse DB 42. The storehouse DB 42 records the address of the storage space 20 and information about the tire set 100 which is stored in the storage space 20 in association with each other. In the case of FIG. 8, the storehouse DB 42 includes an address, a state, a customer ID, and tire information. Here, “State” denotes the present state of the storage space 20 which is selected from “Stored state”, “Empty state” and “Reserved state”. The stored state is a state where the tire set 100 is housed in the storage space 20, and the empty state is a state where the tire set 100 to be housed in the storage space 20 is not present. The reserved state is a state where the tire set 100 is not housed yet in the storage space 20 but it is decided that it will be housed in the storage space 20 in the near future. For example, when the deposit reservation is accepted, the storage space 20 corresponding to the deposit reservation becomes “Reserved state.” The customer ID is an identification code of the customer 110 who owns the tire set 100 which is housed in the storage space 20 or that will be stored in it. When the storage space is empty, Null is recorded in the customer ID. The tire information is information about the tire set 100 which is housed in the storage space 20 or that will be stored in it, such as a tire size, a manufacturer name or the like. When the storage space is empty, Null is recorded in the tire information.

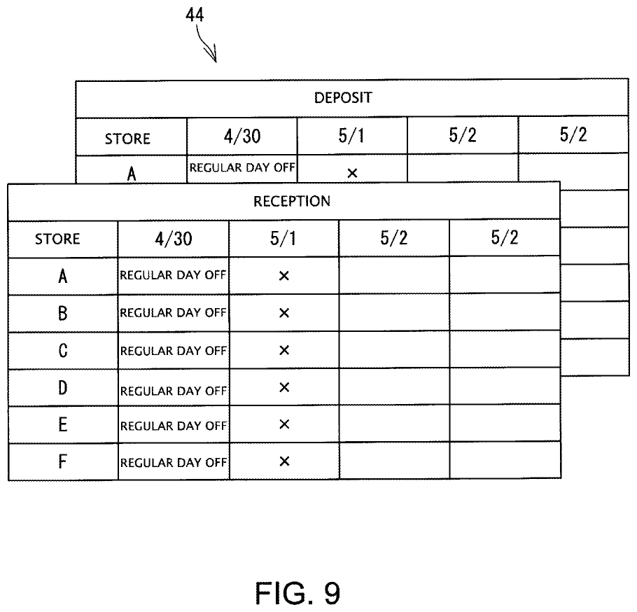

The management device 12 refers to the reservation DB 40 and the storehouse DB 42 to manage the storage state of the tire set 100. Specifically, when it is necessary to receive or deposit the tire set 100, staff of the store 120 operate the reception terminal 122 to make a reservation to the management device 12. When the reservation is made, the display screen of the reception terminal 122 displays a reservation calendar 44 as shown in FIG. 9. The reservation calendar 44 is a calendar showing whether the reception reservation and the deposit reservation can be accepted for each date and store. In the case of FIG. 9, mark X indicates that a reservation cannot be accepted. Upon the request from the reception terminal 122, the reservation calendar 44 is generated by the management device 12. That is, the management device 12 refers to the reservation DB 40 to check the present reserved state and generates the reservation calendar 44.

The staff of the store 120 refer to the reservation calendar 44 to reserve the receiving or depositing of the tire set 100. Information about the applied reservation is sent to the management device 12 through the reception terminal 122. The management device 12 updates the reservation DB 40 according to the received reservation information.

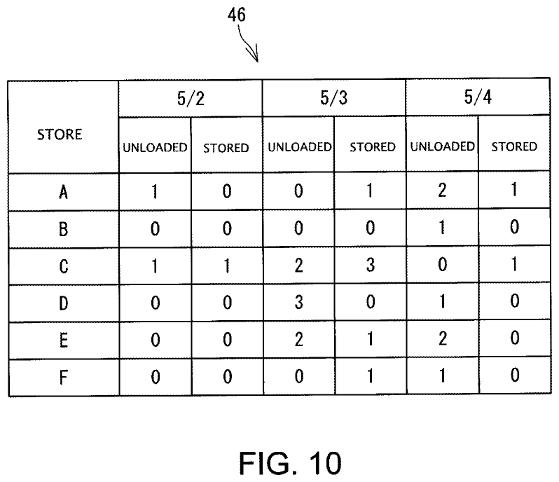

Upon a request from the worker through the worker terminal 16, the management device 12 generates the delivery schedule 46 in accordance with the reservation DB 40. FIG. 10 is a view showing an example of the delivery schedule 46. The delivery schedule 46 records the number of the tire sets 100 received from the store 120 and the number of the tire sets 100 which are received by the store 120 for each date and each store 120. The driver of a transporting vehicle visits the respective store in a circulative manner to collect and deliver the needed tire sets in accordance with the delivery schedule 46.

When the start of work is instructed from the worker through the worker terminal 16, the management device 12 generates a work inventory by referring to the reservation DB 40 and the storehouse DB 42. The work inventory is data including identification information of the tire sets 100 to be unloaded and stored, and their locations in the storehouse. The contents of the work inventory are displayed on the worker terminal 16. In this case, the contents of the work inventory are dividedly displayed on a work confirmation screen 48 and a map display screen 50.

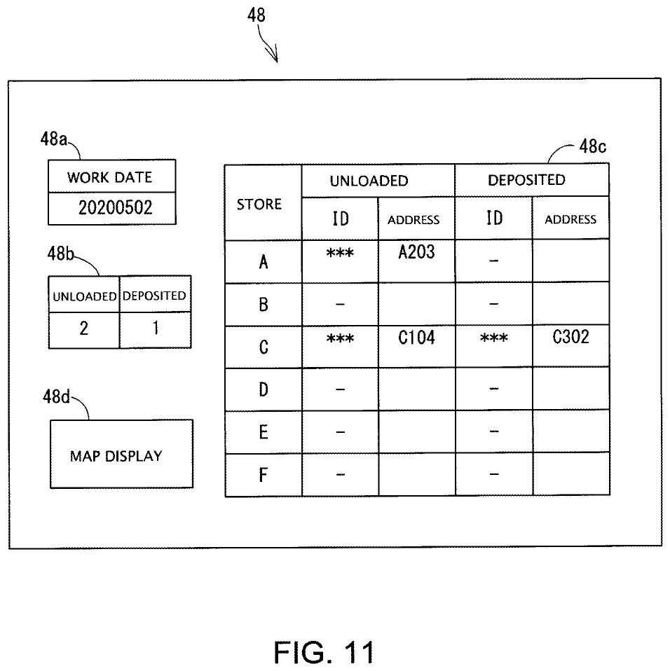

FIG. 11 is a diagram showing an example of the work confirmation screen 48. The work confirmation screen 48 has a working date entry frame 48a, a total number display frame 48b, a list display frame 48c, and a map display button 48d. A working date can be entered into the working date entry frame 48a. By entering the working date, a work initiation instruction is sent to the management device 12. The total number display frame 48b indicates a total number of the tire sets 100 to be unloaded and a total number of the tire sets 100 to be stored on the entered working date. Below, the tire set 100 to be unloaded is called “unloading set 100a” and the tire set 100 to be stored is called “storing set 100b.”

The list display frame 48c indicates a list of the unloading sets 100a and the storing sets 100b. In this list, ID of the customer 110 having the respective tire sets 100 is associated with the addresses of the tire sets 100 in the storehouse. The map display button 48d is operated to switch the display of the display unit 16d to the map display screen 50. FIG. 12 is a diagram showing an example of the map display screen 50. The map display screen 50 includes a map display frame 50a and a confirmation screen display button 50b. The confirmation screen display button 50b is operated to switch the display screen of the display unit 16d to the work confirmation screen 48.

The map display frame 50a displays a layout image showing the layout of the storage spaces 20. More specifically, the layout image shows that cells 51 corresponding to the storage spaces 20 are two-dimensionally arranged in correspondence with the actual layout of the storage spaces 20. Also, the respective storage spaces 20 are affixed with a numerical value indicating the address of each storage space 20. Each cell 51 is also painted a different color depending on the state of the corresponding storage space 20 and the operation contents. In the case of FIG. 12, gray hatching indicates the storage space 20 where the unloading set 100a is housed, oblique hatching indicates the storage space 20 where the storing set 100b is housed, blackened indicates the storage space 20 which is empty, and cross-hatching indicates the storage space 20 which is reserved. The display unit 16d is designed to indicate the above layout images, so that the worker can visually recognize the locations of the unloading set 100a and the storing set 100b in the storehouse 14.

Even when the above layout image is used to find the storage space 20 where the work is performed, the worker takes a long time because it is necessary to confirm by comparing the displayed layout with the actual layout in the storehouse 14. Also, if the display unit 16d showing the layout image is fixed at a particular location, the worker memorizes the layout image and compares the memorized layout image with the actual layout to look for the target storage space 20, so that there is a possibility of making an error in selecting the target storage space 20.

Accordingly, the storage spaces 20 are provided with the annunciator 22 in this case so that the worker can find the target storage space 20 more quickly. The storage spaces 20 are also provided with the tire sensor 24 to more surely prevent an error of selecting the storage space 20. This will be described in detail below.

Upon receiving a work initiation instruction from the worker, the management device 12 displays the above-described work inventory and switches on the annunciator 22 of the storage space 20 in which the unloading set 100a is housed. If there are a plurality of unloading sets 100a, all their corresponding plurality of annunciators 22 are switched on. In such a case, since the annunciator 22 is a lamp, the management device 12 switches on the lamps corresponding to the unloading sets 100a. Thus, the worker can specify the storage spaces 20 where the unloading sets 100a are stored by checking the lighting state of the lamps without comparing the layout image with the actual layout. As a result, a length of time the worker needs to find the unloading set 100a can be reduced substantially.

When the worker takes out the unloading set 100a from the storage space 20, the detection result of the tire sensor 24 is changed from the “presence state” to the “absence state.” When the change occurs, the management device 12 determines that the unloading set 100a is taken out from the corresponding storage space 20 and switches off the annunciator 22 provided on the storage space 20. Also, the management device 12 updates the storehouse DB 42 to change the state of the storage space 20 from the “storage state” to the “empty state” or to the “reservation state.”

Thus, when the storage space 20 is provided with the tire sensor 24 for detecting the presence or absence of the tire set 100, the management device 12 can grasp the progress of the work of taking out the tire set 100 from the storage space 20. Accordingly, the storehouse DB 42 can always be kept in a correct state.

In this case, when the unloading set 100a is taken out from the storage space 20, the annunciator 22 is switched off. By configuring in this way, each worker can grasp the work results of other workers, and unnecessary work of looking for the storage space 20 can be prevented. For example, it is assumed that the annunciator 22 is not provided and a plurality of workers look for the unloading set 100a based on the work inventory. In such a case, there is a possibility that one worker will find a certain unloading set 100a and take it out, while other workers do not know this and continue to look for the same unloading set 100a. On the other hand, with the constitution of the present case where the corresponding annunciator 22 is switched off when the unloading set 100a is taken out, the unloading set 100a which has already been taken out by one worker is prevented from being looked for needlessly by another worker.

The storage space 20 for housing the storing set 100b is empty until the storing set 100b is housed and its availability is readily grasped. Therefore, the annunciator 22 corresponding to the storing set 100b is not switched on in this case. On the other hand, based on the detection result of the tire sensor 24, the management device 12 monitors whether the storing set 100b is housed into the corresponding storage space 20 and, if housed, updates the storehouse DB 42.

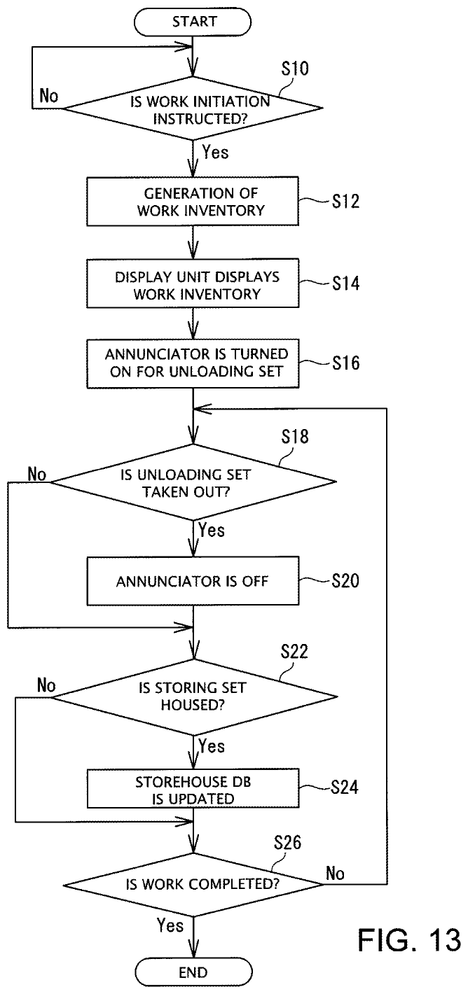

FIG. 13 is a flowchart showing a flow of processing of the management device 12 in work of taking out and storing the tire set 100. As shown in FIG. 13, when the worker inputs a work initiation instruction (Yes in S10), the management device 12 generates a work inventory (S12). As described above, the work inventory is generated in accordance with the reservation DB 40 and the storehouse DB 42. Subsequently, the management device 12 displays the layout image and the work list reflecting the work inventory on the display unit 16d of the worker terminal 16 (S14). The worker refers to the work list and the layout image to grasp an approximate location of the storage space 20 which is subject to the work, and approximate information about the tire set 100 to be unloaded or stored. Subsequently, the management device 12 switches on all the annunciators 22 corresponding to the unloading sets 100a (S16). Thus, the worker can easily grasp the actual locations of the unloading sets 100a even if the worker does not correctly memorize the locations of the unloading sets 100a.

Then, the management device 12 monitors the progress of the unloading and storing work of the tire set 100 in accordance with the detection result of the tire sensor 24 provided in each storage space 20 (S18, S22). Specifically, the management device 12 checks whether the unloading set 100a is taken out (S18). In other words, the management device 12 confirms whether the tire sensor 24 provided in the storage space 20 where the unloading set 100a is housed is switched from the presence state to the absence state. When it is detected that the unloading set 100a is taken out (Yes in S18), the management device 12 switches off the annunciator 22 of the storage space 20 where the unloading set 100a is taken out, and updates the storehouse DB 42 to change the state of the storage space 20 to the “empty state” or the “reservation state” (S20).

The management device 12 confirms whether the storing set 100b is housed in the storage space 20 (S22). Specifically, the management device 12 confirms whether the tire sensor 24 provided in the storage space 20 in which the storing set 100b is housed is switched from the absence state to the presence state. When it is detected that the storing set 100b is housed (Yes in S22), the management device 12 updates the storehouse DB 42 to change the storage space 20 to the “storage state” (S24).

Then, the management device 12 confirms whether the scheduled work is completed (S26). If not completed (No in S26), the management device 12 repeats step S18 through step S26. Meanwhile, when all the unloading sets 100a are taken out and all the storing sets 100b are housed (Yes in S26), the series of processing is ended.

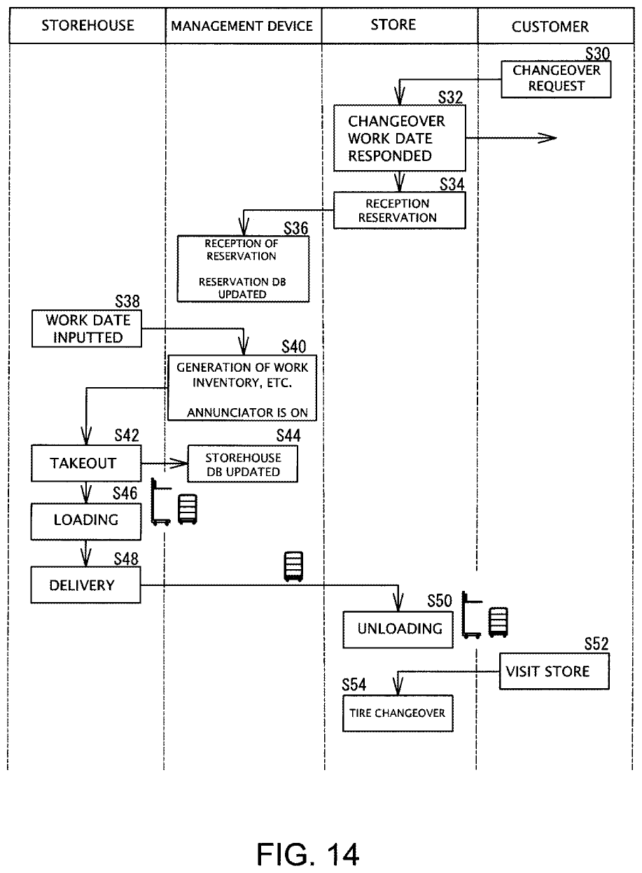

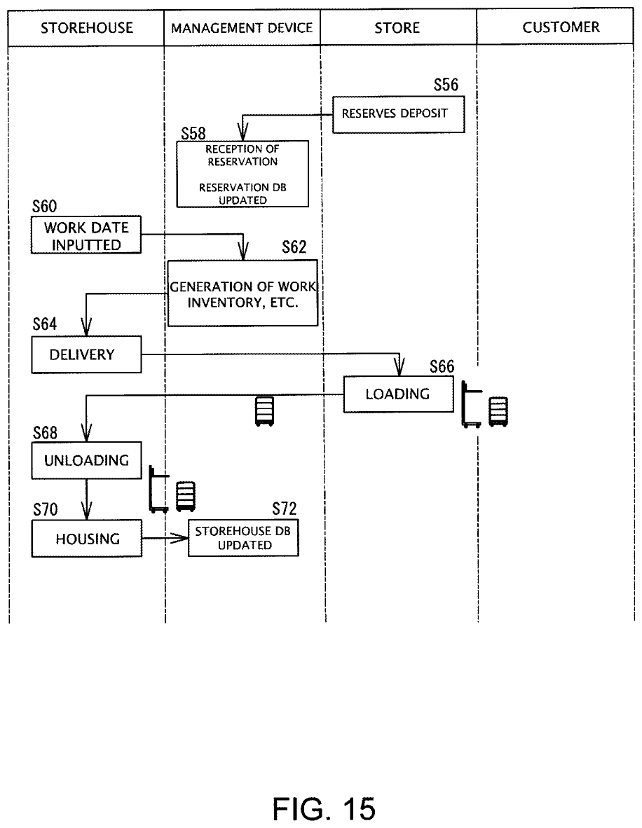

Next, the flow of the whole tire storage service will be briefly explained with reference to FIG. 14 and FIG. 15. In the tire storage service, first the customer 110 requests the store 120 to change the tires over (S30). The store 120 determines a working date for the tire changeover and responds to the customer 110 (S32). The store 120 outputs a reception reservation to the management device 12 so that the tire set 100 of the customer 110 is received by the tire changeover working date (S34). The management device 12 updates the reservation DB 40 to reflect the reception reservation (S36). Here, only the reception reservation is made, but the deposit reservation for depositing the tire set 100 removed from the automobile may also be made when the reception reservation is made.

The worker in the storehouse 14 inputs the work date into the worker terminal 16 as a work initiation instruction (S38). Upon receiving the work initiation instruction, the management device 12 generates the work inventory and the delivery schedule 46 and also switches on the annunciator 22 corresponding to the unloading set 100a (S40). The worker moves to the location of the unloading set 100a in accordance with the work inventory and the annunciator 22 and takes out the unloading set 100a from the storage space 20 (S42). If necessary, the lifter 34 is used. When it is detected that the unloading set 100a has been taken out, the management device 12 updates the storehouse DB 42 to reflect the change (S44).

The taken-out unloading set 100a is placed on and fastened to the platform cart 32. The worker uses the platform cart 32 to carry the unloading set 100a to a transportation vehicle. Subsequently, the worker loads the unloading set 100a in the state fixed to the platform cart 32 onto the transportation vehicle (S46). The lifter 34 may also be used for loading. The driver of the transportation vehicle delivers the unloading set 100a to the store 120 in accordance with the delivery schedule 46 generated by the management device 12 (S48). Upon arriving at the store 120, the unloading set 100a is unloaded by the lifter 34 (S50). At this time, the unloading set 100a is in a state fixed to the platform cart 32. Staff of the store 120 use the platform cart 32 to carry the unloading set 100a to a tire exchanging place.

Meanwhile, the customer 110 drives to the store 120 on the changeover work day (S52). Then the staff of the store 120 work to change the tires over (S54). After the tire changeover, the staff of the store 120 reserve the storehouse 14 to deposit the tire set (namely, the storing set 100b) removed from the automobile of the customer 110 (S56). The management device 12 updates the reservation DB 40 to reflect the deposit reservation (S58).

When the work initiation instruction is input on the delivery day of the storing set 100b, the management device 12 generates the work inventory and the delivery schedule 46 (S60, S62). The driver of the transportation vehicle drives to the store 120 in accordance with the delivery schedule 46 (S64), and the storing set 100b is loaded at the store 120 (S66). At this time, the storing set 100b is placed on and fastened to the platform cart 32, and, the lifter 34 is used for loading.

When the transportation vehicle arrives at the storehouse 14, the storing set 100b is unloaded by using the lifter 34 (S68). The worker carries the unloaded storing set 100b to the target storage space 20 by the platform cart 32. Then the worker houses the storing set 100b into the storage space 20 (S70). When the storing set 100b is housed in the storage space 20, the management device 12 updates the storehouse DB 42 to reflect the change (S72).

It is apparent from the above description that the annunciator 22 corresponding to the unloading set 100a is switched on at the time of the unloading work according to the tire management system 10. Thus, the worker can quickly and accurately grasp the location of the unloading set 100a, so that the time required for the unloading work can be reduced. In this case, the tire sensor 24 automatically discriminates between unloading of the tire set 100 from the storage space 20 and storing of it into the storage space 20. As a result, erroneous takeout of the tire set 100 can be prevented effectively in this case. In addition, the pallet 30, the platform cart 32 and the lifter 34 are used for the storage and transportation of the tire set 100 in this case. Thus, a burden on the worker can be reduced.

The above-described configuration is one example, and when the tire set 100 is at least unloaded or stored, other configurations may be changed if an address of the storage space 20 in the storehouse where the tire set 100 is unloaded or stored is displayed on the worker terminal 16 and the annunciator 22 provided on the subject storage space 20 is also switched on. For example, unloading and storing of the tire set 100 are automatically judged by the tire sensor 24 in the above description, but the tire sensor 24 may be omitted. In such a case, the worker operates the worker terminal 16 to notify the completion of unloading and storing of the tire set 100 to the management device 12.

Only the annunciator 22 corresponding to the unloading set 100a is switched on in the above description, but the annunciator 22 corresponding to the storing set 100b may be switched on in addition to or instead of the unloading set 100a. Thus, erroneous work of housing the storing set 100b into a wrong storage space 20 can be prevented effectively. In this case, the tire set 100 is stored in a state placed on the pallet 30, and the tire set 100 which is on the pallet 30 is carried and transported in a state fixed to the platform cart 32. However, the use of the pallet 30 and the platform cart 32 can be omitted.

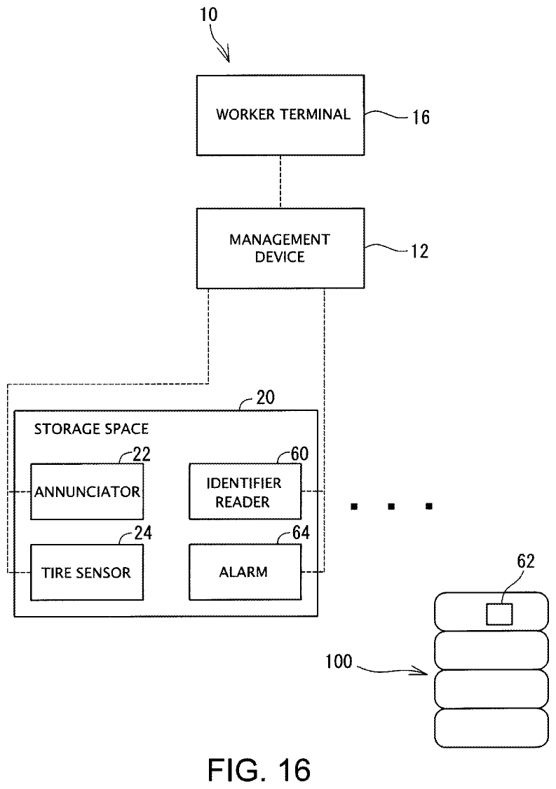

As another embodiment as shown in FIG. 16, an identifier reader 60 may be provided on each storage space 20, and an identifier 62 readable by the identifier reader 60 may be attached to the tire set 100. The identifier 62 is not limited to a particular form if the identification information of the tire set 100 can be read by the identifier reader 60. Therefore, the identifier 62 may be, for example, a barcode, a tag describing a character string or an IC tag recording the identification information. The identifier reader 60 may be a barcode reader for reading a barcode, an OCR (optical character reader) for optically reading and recognizing a character string, or an IC reader for reading information recorded on an IC tag. The identifier reader 60 is arranged in position so that the identifier 62 of the tire set 100 is read when the tire set 100 is housed in the storage space 20. For example, when the identifier 62 is a two-dimensional barcode applied to the wheel part of the uppermost tire, the barcode reader as the identifier reader 60 may be arranged in position on the ceiling of the storage space 20 to face the wheel part.

The identifier reader 60 sends the read identification information to the management device 12. The management device 12 grasps a housed state of the tire set 100 from the obtained identification information. Thus, the provision of the identifier reader 60 for automatically reading the identifier 62 of the tire set 100 makes it possible to reliably prevent erroneous unloading of a wrong tire set 100.

As another embodiment, the management device 12 monitors the presence or absence of erroneous work in parallel with the processing in step S16 through step S26 shown in FIG. 13, and may output an alarm in the case of erroneous work. The erroneous work means that a tire set 100 is taken out from a non-target storage space 20 where unloading or storing is not scheduled, or a tire set 100 is housed in a non-target storage space 20.

Specifically, if the tire sensor 24 provided in the non-target storage space 20 is switched from the presence state to the absence state or vice versa, the management device 12 judges that the erroneous work has occurred. In such a case, the management device 12 outputs an alarm indicating the occurrence of the erroneous work. The alarm is not limited to a particular type if it can attract the attention of the worker. Therefore, the alarm may be an alarm sound outputted within the storehouse 14 or a certain message outputted from the worker terminal 16. As shown in FIG. 16, an alarm device 64 may be provided in each storage space 20 to output an alarm within it. For example, a buzzer which functions as the alarm device 64 may be provided in each storage space 20 to output an alarm using the buzzer. As still another embodiment, the annunciator 22 may be used as the alarm device 64. In such a case, the operation mode of the annunciator 22 may be switched between a case where it functions as an annunciator and a case where it is used as an alarm device. For example, a lamp used as the annunciator 22 is continuously lit when a target storage space 20 is to be notified, and the lamp is made to blink as the annunciator 22 if erroneous work occurs. Thus, the presence or absence of the erroneous work is monitored and an alarm is outputted in the case of erroneous work, so that an erroneous takeout of a wrong tire set 100 can be prevented more surely.

### REFERENCE SIGNS LIST

10 tire management system, 12 management device, 14 storehouse, 15 shelf, 16 worker terminal, 20 storage space, 22 annunciator, 24 tire sensor, 26 address plate, 28 identification tag, 30 pallet, 32 platform cart, 34 lifter, 40 reservation DB, 42 storehouse DB, 44 reservation calendar, 46 delivery schedule, 48 work confirmation screen, 50 map display screen, 60 identifier reader, 62 identifier, 64 alarm device, 100 tire set, 110 customer, 120 store, 122 reception terminal

1. A tire management system comprising:
a management device which manages a storage state of a tire set in a storehouse provided with a plurality of storage spaces each capable of storing a single tire set;
a worker terminal which is used by a worker working to unload or store the tire set; and
an annunciator which is provided on each of the storage spaces and, when switched on, generates a visual or audible change to draw the worker's attention to a corresponding storage space; wherein:
when the tire set is unloaded or stored, the management device displays on the worker terminal an address of the storage space in the storehouse where the tire set is to be taken out or stored, and also switches on the annunciator provided on the target storage space.

2. The tire management system according to claim 1, wherein:
the management device switches off the annunciator provided on the storage space when the tire set is taken out from the target storage space or the tire set is stored in the target storage space.

3. The tire management system according to claim 1, further comprising:
a tire sensor which is provided in the respective storage spaces to detect the presence or absence of the tire set in the storage spaces; and
the management device manages the progress of the unloading and storing work of the tire set in accordance with the detection result of the tire sensor.

4. The tire management system according to claim 3, wherein:
the management device outputs an alarm when the tire sensor provided in the storage space which is not an object of the unloading and storing work has a change in the detection result of the presence or absence of the tire set.

5. The tire management system according to claim 1, further comprising:
an identifier reader which is provided in each of the storage spaces to read an identifier attached to the tire set stored in the storage space, and transmit the read result to the management device.

6. The tire management system according to claim 1, wherein:
the management device includes a reservation database which records a tire set receiving or depositing reservation transmitted from outside and a storehouse database which records the arrangement of the tire sets in the storehouse; and
when the management device receives a work initiation instruction from the worker terminal, it specifies the location where the tire set is to be taken out and stored in the storehouse in accordance with the reservation database and the storehouse database.

7. The tire management system according to claim 1, further comprising:
a pallet on which four tires configuring the tire set are placed in a vertically stacked state; and
a platform cart which has wheels on its bottom surface and on which the four tires are placed and fixed together with the pallet; wherein:
the tire set is stored in the storage space in a state placed on the pallet and transported in a state placed on and fixed to the platform cart.

8. The tire management system according to claim 1, wherein:
the plurality of storage spaces are arranged vertically in two or more stages in the storehouse; and
the management device determines the number of stages of the storage spaces for storing the tire sets depending on the size of the tire set.
